(19) United States
(12) Patent Application Publication
(10) Pub. No.: US 2011/0244806 A1
(43) Pub. Date: Oct. 6, 2011

(54) DYNAMIC CONTROL CHANNEL MONITORING SET FOR MULTI-CARRIER OPERATIONS

(75) Inventors: Sylvie Gomes, Douglaston, NY (US); Christopher Cave, Dollard-des-Ormeaux (CA); Diana Pani, Montreal (CA)

(73) Assignee: INTERDIGITAL PATENT HOLDINGS, INC., Wilmington, DE (US)

(21) Appl. No.: 13/078,170

(22) Filed: Apr. 1, 2011

Related U.S. Application Data
(60) Provisional application No. 61/320,404, filed on Apr. 2, 2010.

(51) Int. Cl. H04B 17/00

(52) U.S. Cl. 455/67.11

(57) ABSTRACT

Systems, methods, and devices are disclosed herein for dynamically controlling channel monitoring in a multi-carrier environment. A UE may monitor one or more channels associated with active carriers. The monitoring by the UE may be established via a network pre-configuring the HS-SCCHs and/or specifying which HS-SCCHs the UE should monitor depending on which carriers are activate. Further, the network may pre-configure a list of HS-SCCHs for each carrier, and the UE may autonomously, following pre-determined rules, increase or decrease the number of HS-SCCHs it monitors on each carrier. In addition, the network may indicate in an HS-SCCH order which HS-SCCHs the UE should stop or start monitoring.

### CROSS REFERENCE TO RELATED APPLICATIONS

This application claims the benefit of U.S. Provisional Application No. 61/320,404, filed Apr. 2, 2010, the contents of which are hereby incorporated by reference herein.

### BACKGROUND

User equipment (UE) may have multi-carrier capabilities. A UE may monitor multiple channels, such as High Speed-Shared Control Channels (HS-SCCHs), associated with the carriers. A UE may be assigned a maximum number of HS-SCCHs to monitor, with a maximum number of HS-SCCHs per carrier. If all carriers are activated, the maximum number of configured HS-SCCHs per carrier is limited by the maximum number of HS-SCCH across the carriers. If one or more carriers are deactivated, the HS-SCCH configuration may remain identical, and, the maximum number of HS-SCCHs across all carriers is not reached. This unnecessarily increases the HS-SCCH blocking probability, i.e., probability that at least one of the UEs scheduled for transmission in a transmission time interval (TTI) will get blocked because all of its monitored HS-SCCH are being used to schedule other UEs in the same TTI.

### SUMMARY

Systems, methods, and instrumentalities are disclosed to control channel monitoring for multi-carrier capable operations. A UE may be capable of monitoring one or more channels on one or more active carriers. The UE may receive channel monitoring configurations. Each channel monitoring configuration may identify an active carrier configuration associated with one or more channels. The UE may detect a carrier change. The carrier change may include a carrier activation and/or a carrier deactivation (e.g., the number and/or identity of active carriers may change). The UE may detect a first channel for monitoring on an activated carrier when the carrier change is a carrier activation. The first channel may be identified by a first channel monitoring configuration corresponding to a first active carrier configuration associated with the carrier change. The first channel monitoring configuration may be one of the channel monitoring configurations.

In response to a carrier change, the UE may monitor more or less channels on each existing active channel (e.g., a channel that was active before the carrier change and remains active after the carrier change). When the carrier change is a carrier activation, the UE may stop monitoring one or more channels on one or more existing active channels (e.g., the one or more channels may be deleting for monitoring). The deleted channel or channels may be identified by the channel monitoring configuration corresponding to the set of active carriers present after the carrier change. When the carrier change is a carrier deactivation, the UE may start monitoring one or more channels on one or more existing active channels. The added channels may be in addition to channels that may already be monitored on the one or more existing active channels (e.g., the one or more channels may be added for monitoring). The adding and/or deleting may maintain a maximum number of channels monitored.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 illustrates an example for controlling channel monitoring for multi-carrier operations; and

FIG. 3 illustrates an example for controlling channel monitoring for multi-carrier operations.

### DETAILED DESCRIPTION OF ILLUSTRATIVE EMBODIMENTS

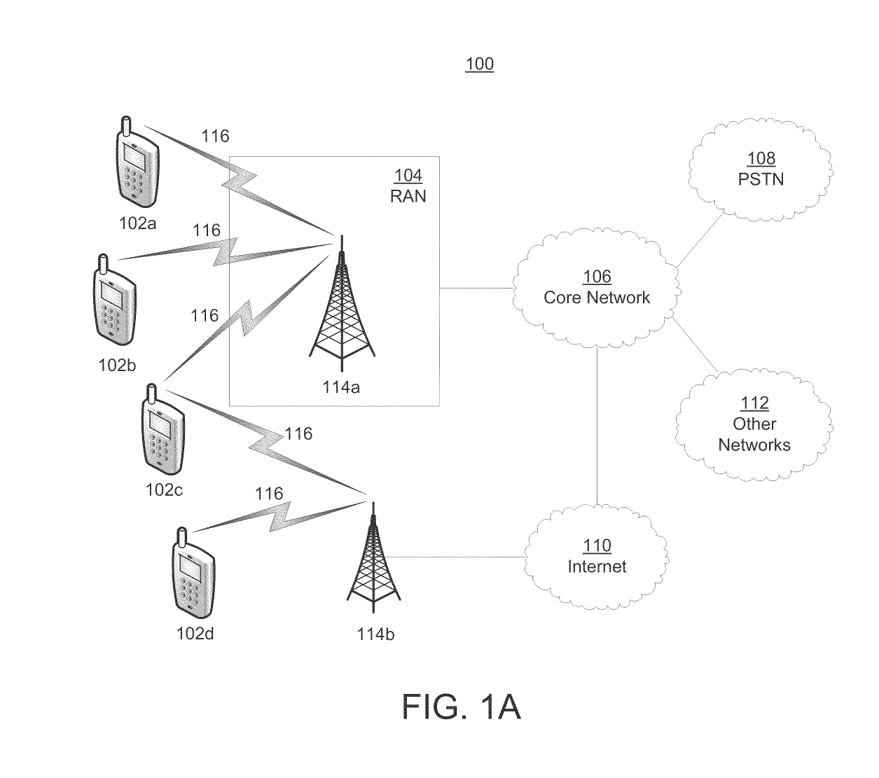

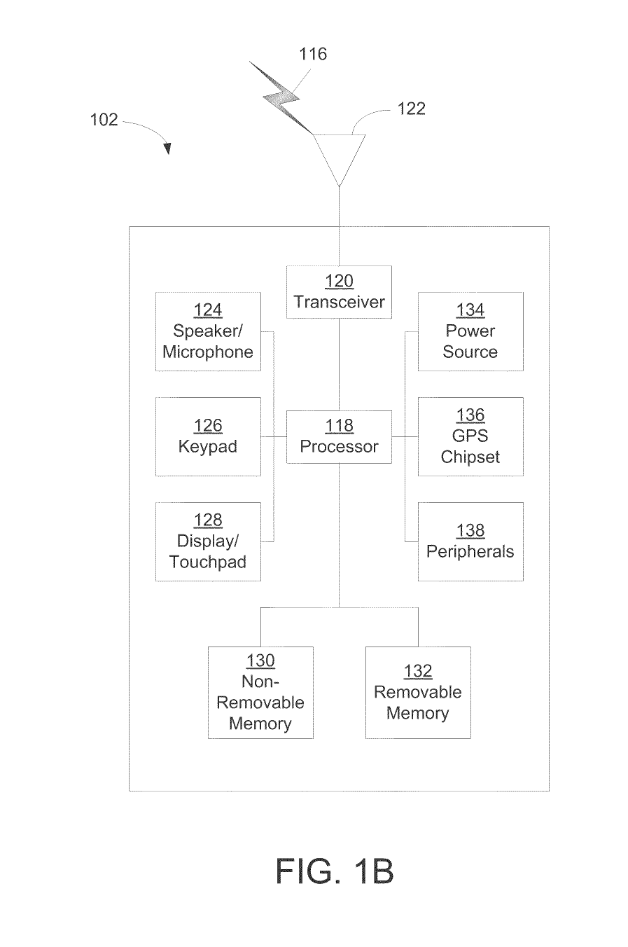

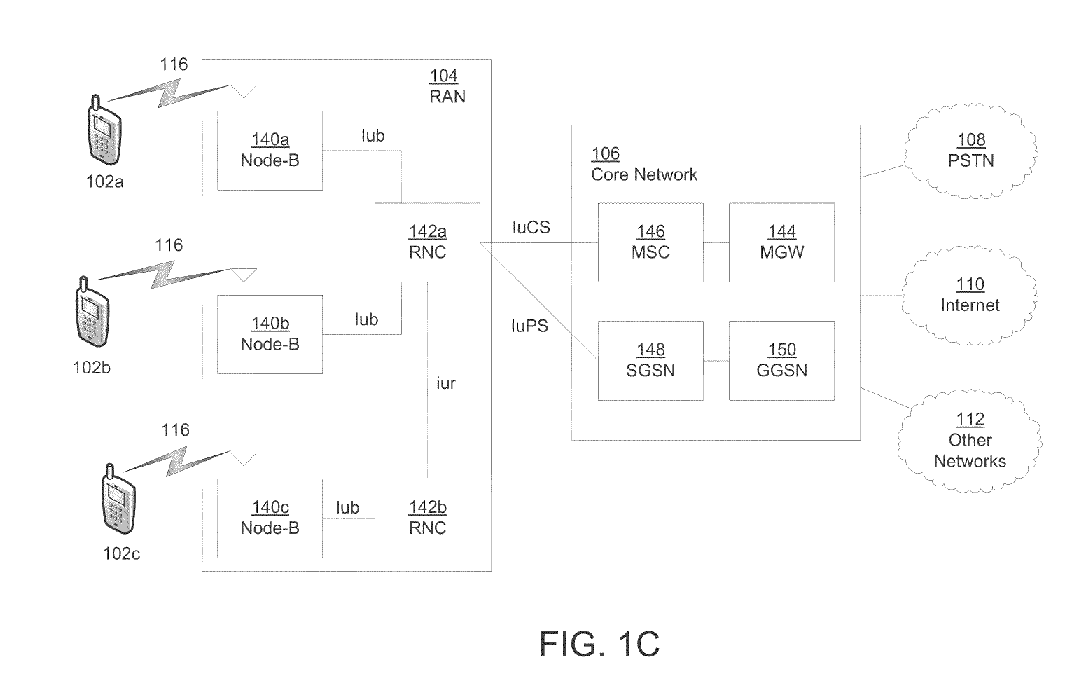

FIGS. 1-3 may relate to exemplary embodiments in which the disclosed systems, methods, and instrumentalities may be implemented. However, while the present invention may be described in connection with exemplary embodiments, it is not limited thereto and it is to be understood that other embodiments may be used or modifications and additions may be made to the described embodiments for performing the same function of the present invention without deviating therefrom.

Systems, methods, and instrumentalities are disclosed to control channel monitoring on carriers of a UE, including a method for controlling channel monitoring for multi-carrier capable operations. A UE may be capable of monitoring one or more channels on one or more active carriers. According to the method, the UE may receive channel monitoring configurations. Each channel monitoring configuration may identify an active carrier configuration associated with one or more channels. The UE may detect a carrier change. The carrier change may include a carrier activation and/or a carrier deactivation (e.g., the number and/or identity of active carriers may change). The UE may add a first channel for monitoring on an activated carrier when the carrier change is a carrier activation. The first channel may be identified by a first channel monitoring configuration corresponding to a first active carrier configuration associated with the carrier change. The first channel monitoring configuration may be one of the channel monitoring configurations described above.

In response to a carrier change, the UE may monitor more or less channels on each existing active channel (e.g., a channel that was active before the carrier change and remains active after the carrier change). When the carrier change is a carrier activation, the UE may stop monitoring one or more channels on one or more existing active channels (e.g., the one or more channels may be deleting for monitoring). The deleted channel or channels may be identified by the channel monitoring configuration corresponding to the set of active carriers present after the carrier change. When the carrier change is a carrier deactivation, the UE may start monitoring one or more channels on one or more existing active channels The added channels may be in addition to channels that may already be monitored on the one or more existing active channels (e.g., the one or more channels may be added for monitoring). The adding and/or deleting may maintain a maximum number of channels monitored.

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a notebook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116.

The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

The communications systems described above, or portions thereof, may be used when controlling channel monitoring on carriers of a UE as described herein.

A UE may be configured with a number of carriers that are each configured to monitor one or more channels. The number of channels that may be monitored on each active carrier may be preconfigured, as well as the total number of channels monitored on the UE. For example, a 4-carrier capable UE may be configured to monitor a maximum 12 High Speed-Shared Control Channel (HS-SCCHs) in total, with a maximum of 4 HS-SCCHs per active carrier. The 4-carrier capable UE may monitor one HS-SCCH on an anchor carrier for enhanced serving cell change independent of the number of carriers configured on the downlink. According to another example, a 3-carrier capable UE may be configured to monitor a maximum 9 HS-SCCHs in total, with a maximum of 4 HS-SCCHs per active carrier. The 3-carrier capable UE may monitor one HS-SCCH on an anchor carrier for enhanced serving cell change independent of the number of carriers configured on the downlink.

When a carrier on the UE is activated or deactivated, the total number of channels monitored on the UE may not be reached. As an example, for a 4-carrier capable UE, when 4 carriers are activated, there may be 3 HS-SCCHs configured per active carrier for a total of 12 HS-SCCHs. If one carrier is deactivated, the total monitored HS-SCCHs may be 9. In another example, for a 3-carrier capable UE, when 3 carriers are activated, there may be 3 HS-SCCHs configured per active carrier for a total of 9 HS-SCCHs. If one carrier is deactivated, the total number of monitored HS-SCCHs may be 6.

The monitoring performed by a UE may be controlled to adapt to carrier deactivations and/or activations. The adaptation may be performed autonomously by the UE, performed via instructions from a network, or a combination of both. The adaptation may allow the UE, for example, to monitor a maximum number of channels, such as HS-SCCHs for example, across the carriers.

A network may pre-configure a maximum allowed number of HS-SCCHs per carrier, independent of the number of carriers activated, and may monitor the allowed number of HS-SCCHs across the active carriers. As an example, for a 4-carrier capable UE, the network may pre-configure 4 HS-SCCHs per carrier (i.e., 4/4/4/4); however, the UE may be configured to use 12 HS-SCCHs in total. In this example, the UE may monitor 3 HS-SCCHs per carrier (i.e., 3/3/3/3). If 3 carriers are activated (e.g., if one of the 4 carriers is deactivated) the UE may monitor 4 HS-SCCHs for each of the three active carriers (i.e., 4/4/4).

As another example, for a 3-carrier capable UE, the network may pre-configure 4 HS-SCCHs per carrier (i.e., 4/4/4); however, the UE may be configured to use 9 HS-SCCHs in total. In this example, the UE may monitor 3 HS-SCCHs per carrier or 9 HS-SCCHs (i.e., 3/3/3). If 2 carriers are activated (e.g., if one of the 3 carriers is deactivated) the UE may monitor 4 HS-SCCHs for each active carrier (i.e., 4/4).

To adapt to carrier deactivations and/or activations, a UE may change a channel monitoring configuration associated with the carriers on the UE. For example, when a carrier is deactivated, a UE may monitor more HS-SCCHs on the carriers that are active. When a carrier is activated, the UE may monitor fewer HS-SCCHs on the carriers that are active. This may enable the UE to maximize the number of channels, such as HS-SCCHs for example, that may be monitored on the UE for the number of active carriers.

Control of the monitoring by the UE may be implemented in different ways. A network may pre-configure the HS-SCCHs and/or specify which HS-SCCHs the UE may monitor depending on which carriers are activated (e.g., identified active carriers). The network may also pre-configure a list of HS-SCCHs for each carrier for example. The UE may autonomously, following pre-determined rules for example, increase or decrease the number of HS-SCCHs it monitors on each active carrier (e.g., in response to a carrier activation and/or deactivation).

As another example, the network may indicate in an HS-SCCH order which HS-SCCHs the UE may stop or start monitoring. When sending an order for deactivating a frequency, the network may indicate in the same order which additional HS-SCCHs the UE may monitor. When sending an order to activate a frequency, the network may indicate in the same order which HS-SCCHs the UE may stop monitoring.

One or more order types may be described herein for starting and/or stopping UE monitoring of additional HS-SCCHs. Order bits may be used to indicate the HS-SCCHs on which carriers are affected.

Carrier activations and/or deactivations may have transition delays associated therewith. For example, there may be a transition delay before an additional HS-SCCH is to be monitored after a frequency has been deactivated. For example, after a certain number of slots (e.g. 8 slots, 12 slots) after reception of the deactivation order, a UE may start monitoring additional HS-SCCHs.

There may be a transition delay before the UE should stop monitoring an additional HS-SCCH after a frequency has been deactivated. For example, a certain number of slots after the end of the HS-SCCH sub-frame delivering the order of carrier activation, the UE may stop monitoring the additional HS-SCCH.

The transition delay may be hard coded into a UE, for example, in the physical layer. Alternatively, it may be configured by the network in an RRC message. The transition delay may be identical, or different, for deactivation and activation of carriers.

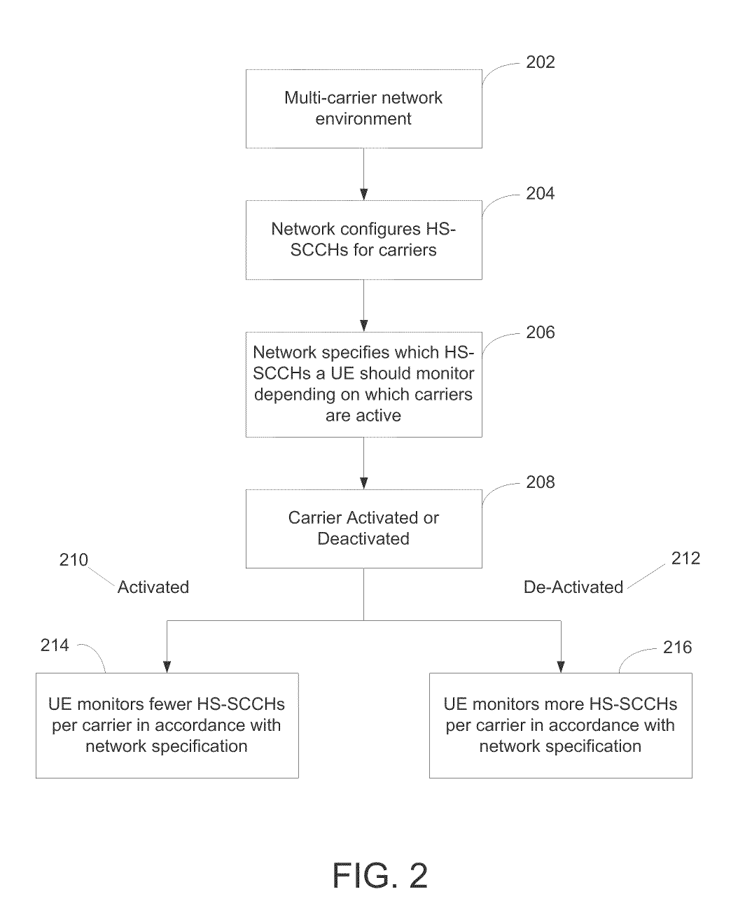

FIG. 2 illustrates an example for controlling channel monitoring for multi-carrier operations. As illustrated in FIG. 2, channel monitoring configurations may originate in a multi-carrier network environment at 202. For example, the multi-carrier network environment may include a network environment, or any portion thereof, as described herein. A network entity may configure channels, such as HS-SCCHs, at 204. At 206, a network entity may specify which channels a UE should monitor depending on which carriers are active. For example, the network entity may use an active carrier configuration to indicate which channels should be monitored on each active carrier. Each channel monitoring configuration may include an active carrier configuration associated with the channels to be monitored by the UE. That is, each channel monitoring configuration may identify one or more channels to monitor on each active carrier.

At 208, a carrier on the UE may be activated or deactivated. If a carrier is activated, at 210, the UE may monitor fewer HS-SCCHs per active carrier at 214. The number of HS-SCCHs and/or the HS-SCCHs per active carrier may be indicated by a network entity, such as in a channel monitoring configuration for example. If a carrier is de-activated, at 212, the UE may monitor more HS-SCCHs per active carrier at 216. The number of HS-SCCHs and/or the HS-SCCHs per active carrier may be indicated by a network entity, such as in a channel monitoring configuration for example.

As illustrated in FIG. 2, a network may pre-configure the HS-SCCHs and/or specify which HS-SCCHs the UE should monitor depending on which carriers are activated. Such channel monitoring configurations may be included in HS-SCCH Information sent in an RRC message to a UE for example. This gives flexibility to the network to configure different numbers of HS-SCCHs across the carriers for initial configuration and allows the network to change the number of monitored HS-SCCHs when a certain carrier is deactivated or re-activated without having to send another configuration (i.e., without the network having to send an additional RRC message).

For a 4-carrier capable UE that may use 9 HS-SCCHs, the UE may use different combinations such as 4/2/2/1, 4/3/1/1, or other combinations using 4 carriers and 9 HS-SCCHs. The following pre-configurations may be defined as follows for the case when the UE is configured for four carriers. Each pre-configuration may represent one or more channel monitoring configurations for example.

Pre-configuration for four carrier operation—an IE which may be called, for example, “HS-SCCH for four carrier operation” may specify for each activated carrier a list of HS-SCCHs the UE should monitor when the four carriers are activated (e.g., when there are four carriers active by initial configuration, by carrier activation and/or deactivation, etc.). This IE may include a list whose length may be the number of carriers, and each element of the list may contain a list of HS-SCCH Channelization Codes.

Pre-configuration for three carrier operation—another IE which may be, for example, called “HS-SCCH for three carrier operation” may specify for each carrier how many and which HS-SCCHs the UE should monitor when three carriers are activated.

Pre-configuration for two carrier operation—another IE which may be called, for example, “HS-SCCH for two carrier operation” may indicate to the UE the list of HS-SCCHs to monitor when two carriers are activated.

Pre-configuration for one carrier operation—another IE which may be called, for example, “HS-SCCH Channelization Code Information” may be used to indicate to the UE the HS-SCCHs to monitor when one carrier is activated. Alternatively, the IE, which may be called, for example, “HS-SCCH for one carrier operation” may be defined.

Instead of using one IE per number of active carriers, a list of pre-configurations may be defined with the index in the list corresponding to the number of active carriers. For example, if one carrier is active, the UE may monitor the HS-SCCHs pre-configured in the first sub-list of HS-SCCH channelization codes of the list, etc. Alternatively, an IE in each-sub-list may indicate for which number of carriers the corresponding HS-SCCH pre-configuration applies.

An HS-SCCH pre-configuration may be limited to one carrier, such as the primary carrier for example, or on a subset of carriers.

The network may indicate different HS-SCCH configurations depending on which carriers are active (e.g., identified active carriers) rather than the number of active carriers. For example, if a first and a second carrier are active, the UE may monitor a different list of HS-SCCHs than when first and third carriers are active. For each active carrier combination, the network may pre-configure a list of HS-SCCHs to monitor.

At initial configuration and/or when a carrier is activated or deactivated, a UE may use a list, as described herein, to determine which HS-SCCHs it may monitor based on the number of current activated carriers. If the set of HS-SCCHs has changed for at least one carrier, the UE may start monitoring the updated HS-SCCHs and stop monitoring previous HS-SCCHs. The monitoring configuration may change from the previous HS-SCCHs to the updated HS-SCCHs a certain number of slots after the end of the HS-SCCH sub-frame delivering the order of carrier deactivation or carrier activation for example.

The implementations described above may be applicable to any number of carriers, including a number of carriers greater than four, by defining additional IEs and/or defining a longer list of pre-configurations for example.

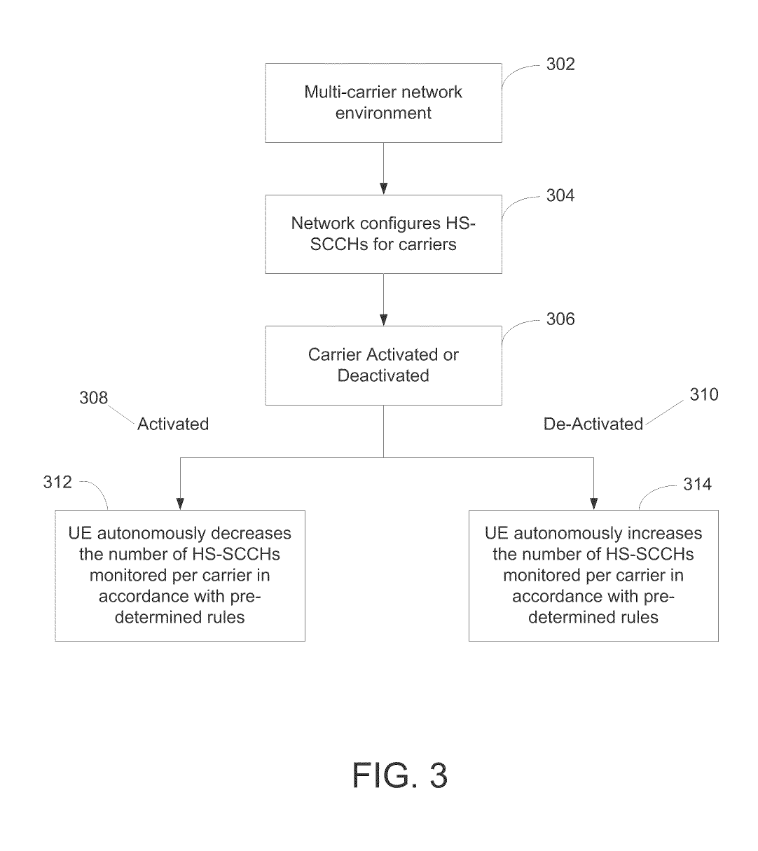

FIG. 3 illustrates an example for controlling channel monitoring for multi-carrier operations. As illustrated in FIG. 3, rules may be generated, in a multi-carrier network environment 302, that enable a UE to autonomously increase or decrease a number of channels monitored per active carrier. The multi-carrier network environment may include a network environment, or any portion thereof, as described herein for example. A network entity may configure channels at 304, such as HS-SCCHs. For example, the network entity may send a channel monitoring configuration to the UE. At 306, a carrier on the UE may be activated or deactivated. If a carrier is activated, at 308, the UE may autonomously decrease the number of HS-SCCHs per active carrier at 312. The number of HS-SCCHs per active carrier may be decreased in accordance with predetermined rules stored on the UE and/or signaled from a network entity. If a carrier is de-activated, at 310, the UE may autonomously increase the number of HS-SCCHs per active carrier. The number of HS-SCCs per active carrier may be increased in accordance with predetermined rules stored on the UE and/or signaled from a network entity at 314.

As illustrated in FIG. 3, a network may pre-configure a list of HS-SCCHs for each carrier, and the UE may autonomously, following pre-determined rules for example, increase or decrease the number of HS-SCCHs it monitors on each carrier (e.g., in response to a carrier activation and/or deactivation). As the UE may have the ability to act autonomously, this may be called partial pre-configuration.

Channel information may be sent to the UE from a network entity. For example, in HS-SCCH Info sent in an RRC message to a UE, the network may specify for each carrier and/or for each HS-SCCH in a list, which HS-SCCHs are configured and which HS-SCCHs are pre-configured. For example, an IE of type Boolean called “pre-config” may be added in the structure “HS-SCCH Channelization Code Information” and/or set to TRUE when the HS-SCCH is pre-configured. The configured HS-SCCHs may correspond to the HS-SCCHs the UE is assigned to monitor in case the corresponding carrier is active. The pre-configured HS-SCCHs may correspond to the additional HS-SCCHs the UE may monitor if the total (maximum) number of HS-SCCHs across the carriers is not exceeded.

Alternatively, there may not be a difference in the way the different HS-SCCHs are configured, but the UE may be aware of a default number of HS-SCCHs to monitor per active carrier. This default number may be hard-coded in the UE and/or configured by the network. In such a case, an implicit or explicit HS-SCCH monitoring order may be defined so that the UE knows which HS-SCCHs to monitor and/or in what order to monitor. For example, a UE may monitor a first HS-SCCH, a next HS-SCCH, and so on. An implicit monitoring order may include a predefined rule or set of rules stored on the UE and/or signaled by the network for example. An explicit monitoring order may be included in one or more monitoring configurations received from the network for example. The UE may also know, from an implicit or explicit monitoring order for example, which HS-SCCHs it may stop monitoring and/or in what order to stop monitoring. For example, a UE may stop monitoring a first HS-SCCH, a next HS-SCCH, and so on. In the case of a configuration of a monitoring order, an RRC IE may be defined and/or L1/L2 signaling added.

When the UE receives a channel monitoring configuration from the network it may perform one or more of the following: monitor configured HS-SCCHs and not pre-configured HS-SCCHs, monitor the first x number of HS-SCCHs on a configured list, such as when there is no explicit pre-configuration, and/or, depending on the number of frequencies activated, monitor some or all of the pre-configured HS-SCCHs in addition to the configured ones, such as by using the same or similar methods as when a frequency is deactivated for example.

When a frequency is deactivated, a UE may monitor additional HS-SCCHs in one or more of the following methods.

Considering one frequency at a time, the UE may monitor one additional HS-SCCH per active carrier until the maximum number of HS-SCCHs per carrier and/or the maximum number of HS-SCCHs over the active carriers are reached. This method may divide uniformly the HS-SCCHs amongst the active carriers. The additional HS-SCCH monitored may be the first pre-configured HS-SCCH in a list of HS-SCCHs (implicit order). Alternatively, the network may explicitly indicate a monitoring order for each pre-configured HS-SCCH. For example, an IE may be added in the HS-SCCH Info that indicates such an explicit monitoring order. The order of the frequencies to consider may be implicit, such as a primary carrier first, then a second carrier, then a third carrier, and so on. The implicit order of the frequencies to consider may also be in an opposite order of carriers or any other order that implicitly indicates an order of frequencies for example. The order of the frequencies may be explicitly configured by the network. For example, the explicit order may be an IE and/or a channel monitoring configuration indicating the order of the frequencies. If the UE has not reached the maximum number of HS-SCCHs over the active carriers after it has gone through the frequencies, it may repeat the process until this maximum is reached and/or without exceeding the maximum number of HS-SCCHs per frequency.

Considering one frequency at a time, the UE may monitor additional HS-SCCHs on a considered frequency up to the maximum number of HS-SCCHs per active carrier and/or up to the maximum number of HS-SCCHs over all frequencies. This method may not divide uniformly the HS-SCCHs amongst the active carriers.

When a frequency is activated, a UE may stop monitoring one or more of the pre-configured HS-SCCHs using one or more of the following methods. For example, the UE may stop monitoring the pre-configured HS-SCCHs across the active carriers, monitor the configured (and not pre-configured) HS-SCCHs on a newly activated frequency, and/or monitor the first x number of HS-SCCHs on the configured list, when there is no explicit pre-configuration.

Considering one frequency at a time, the UE may stop monitoring pre-configured HS-SCCHs on the considered carrier and/or check if the maximum number of HS-SCCHs over the active carriers is still exceeded, taking into account the number of configured HS-SCCHs. If so, the UE may follow the same steps on the next frequenc(ies) until this number goes below the maximum allowed. The UE may then start monitoring the configured HS-SCCHs on the newly activated frequency.

Considering one frequency at a time, the UE may stop monitoring one or more pre-configured HS-SCCHs on that frequency and check if the maximum number of HS-SCCHs across all carriers, including the configured HS-SCCH on the newly activated carrier, is still exceeded. If so, and if it remains pre-configured HS-SCCH on this carrier, the UE may stop monitoring one or more additional HS-SCCHs on that carrier until the maximum number of HS-SCCHs is not exceeded or until there is no pre-configured HS-SCCH on the carrier. In case the number of HS-SCCHs is still exceeded, the UE may perform the same steps on additional carriers.

If the maximum number of HS-SCCHs is not exceeded when the configured channels of the newly activated carrier are monitored, some pre-configured HS-SCCHs on the newly activated carrier may be monitored as well.

There may be a priority list indicating in which order the carriers may be considered for increasing or decreasing the number of HS-SCCHs to monitor. For example, priority may be given to a primary carrier, followed by a second carrier, and so on in order of priority. The network may also specify this frequency consideration order in a channel monitoring configuration.

Alternatively, a pre-configuration may be allowed on a subset of the carriers. For example, it may be allowed on the primary carrier. The other carriers may be configured with the allowed number of HS-SCCHs the UE may monitor when operating with x number of configured carriers. The number of HS-SCCHs the UE monitors on this primary carrier may be determined by the minimum between (the maximum allowed number of HS-SCCHs per carrier) and (the maximum allowed for the number of active carriers minus the number of monitored HS-SCCHs on the active carriers).

The method of implicit HS-SCCH monitoring the UE may follow may be a method set by default, or may be signaled by the network.

As described below, the network may have dynamic control on the number of HS-SCCHs a UE may monitor on each carrier.

For example, at the RRC level, there may be a pre-configuration of HS-SCCHs, but the UE may not autonomously start or stop monitoring the pre-configured HS-SCCHs. Instead, the network may indicate in an HS-SCCH order which HS-SCCHs the UE should stop or start monitoring. This may be limited to the additional HS-SCCHs, or may be extended to the configured and/or pre-configured HS-SCCHs to give even more flexibility to the network.

The network may indicate to the UE which HS-SCCH monitoring method to use. The network may specify that monitoring of additional HS-SCCHs should be ordered by the network, while the UE may autonomously stop monitoring HS-SCCHs as described above. The network may order the UE to stop or start monitoring the additional HS-SCCHs, indicate to the UE which HS-SCCHs to stop or start monitoring among a list of additional pre-configured HS-SCCHs, and/or indicate to the UE which HS-SCCH to stop or start monitoring among the available HS-SCCHs (configured and pre-configured for example).

When sending an order for deactivating a frequency, the network may indicate in the same order which additional HS-SCCHs the UE may monitor. When sending an order to activate a frequency, the network may indicate in the same order which HS-SCCHs the UE should stop monitoring. Alternatively, each time the network sends a carrier activation or deactivation order, it may specify which HS-SCCHs the UE should monitor, in addition to which HS-SCCHs it should stop or start monitoring for example. For doing so, unused order bits or unused combinations of order bits may be reused in the existing HS-SCCH format and/or additional order bits may be used implying a change to the HS-SCCH format. Some examples for a 4-carrier capable UE are described below.

The network may use remaining order bit combinations to indicate which additional HS-SCCHs may be monitored and/or which HS-SCCHs the UE should stop monitoring. For example, three order bit combinations may be available. One order bit combination may indicate to the UE to stop monitoring the additional pre-configured HS-SCCHs. One order bit combination may indicate to the UE to start monitoring the additional pre-configured HS-SCCHs. One order bit combination may indicate to the UE to continue monitoring the same set of HS-SCCHs.

An HS-SCCH format may enable use of additional order bits. For example, x_{ord,x} bits may be used to specify which additional HS-SCCHs in the list should be monitored or which HS-SCCHs the UE should stop monitoring. For example, in the case of 4 DL carriers with a maximum of 12 across the carriers and a maximum of 4 per carrier, an x_{ord,4} bit equal to zero may indicate to stop monitoring the 4^{th} additional HS-SCCH on the first frequency. An x_{ord,4} bit equal to 1 may indicate to start monitoring this HS-SCCH. The same method may be used with an x_{ord,5} bit for a second carrier, an x_{ord,6} bit for a third carrier and/or an x_{ord,7} bit for a fourth carrier for example.

The network may use order bit combinations to define a lower number of order bits.

An order type may be defined for starting or stopping UE monitoring of additional HS-SCCHs, or two order types may be defined: one for starting the UE monitoring of additional HS-SCCHs and another one for stopping the UE monitoring of additional HS-SCCHs. Additionally, the order bits may be used to indicate which HS-SCCHs, on which carrier, are affected.

One example may be to have one order type and to use one order bit or one combination of order bits to provide an indication to the UE to start monitoring the additional HS-SCCHs and another order bit or another combination of order bits to provide an indication to the UE to stop monitoring the additional HS-SCCHs.

Another example may be to have one order type for starting the monitoring of additional HS-SCCHs and another order type for stopping the monitoring of additional HS-SCCHs. Two of the remaining order type combinations may be reused for this purpose.

More examples are provided below.

The same order type may be used by the network for starting and stopping UE monitoring of additional HS-SCCHs. For example, an order type combination may be defined which may be different from the already used ones. Then, the 3 order bits may be used to indicate stop/start monitoring and/or which additional HS-SCCHs are concerned. For example, with 3 order bits, 8 combinations may be available that may have the following example interpretation.

The first combination of the order bits may indicate to the UE to monitor one additional HS-SCCH on each active carrier. The second combination of the order bits may indicate to the UE to stop monitoring one additional HS-SCCH on each active carrier. The third combination of the order bits may indicate to the UE to monitor one additional HS-SCCH on the first, the second, and the third carriers. The fourth combination of the order bits may indicate to the UE to stop monitoring one additional HS-SCCH on the first, second, and third carriers. The fifth combination of the order bits may indicate to the UE to monitor one additional HS-SCCH on the first and second carriers. The sixth combination of the order bits may indicate to the UE to stop monitoring the additional HS-SCCH on the first and second carriers. The seventh combination of the order bits may indicate to the UE to monitor one additional HS-SCCH on the first carrier. The eighth combination of the order bits may indicate to the UE to stop monitoring one additional HS-SCCH on the first carrier.

In another example, an order type combination may be defined. The corresponding 3 order bits may then be used to indicate an HS-SCCH monitoring state for each serving or secondary serving HS-DSCH cell individually. More specifically, each order bit may indicate the HS-SCCH monitoring status for the corresponding serving or secondary serving HS-DSCH cell. For example, an order bit of value 1 or 0 may indicate, for the corresponding serving or secondary serving HS-DSCH cell, one or more of the following. The UE may monitor all or none of the additional pre-configured HS-SCCHs on the associated serving or secondary serving HS-DSCH cell, and/or the UE may monitor one or no additional pre-configured HS-SCCHs on the associated serving or secondary serving HS-DSCH cell.

An HS-SCCH format may be defined so that order bits are available for the network to indicate different combinations of HS-SCCH monitoring across the active carriers.

Two different order types may be used by the network. One order type may be used for starting the UE monitoring of additional HS-SCCHs, and another order type may be used for stopping the UE monitoring of additional HS-SCCHs. For example, two order type combinations may be defined. Then, the 3 order bits may be used by the network to indicate which HS-SCCHs the UE should stop or start monitoring.

For example, for the order type used for stopping the monitoring of additional HS-SCCHs, 3 order bits may be available so there may be 8 possible combinations that may be used as follows. A first combination may indicate to stop one HS-SCCH on the first carrier. A second combination may indicate to stop one HS-SCCH on the first carrier and one HS-SCCH on the second carrier. A third combination may indicate to stop one HS-SCCH on the first carrier, the second carrier, and the third carrier. A fourth combination may indicate to stop one HS-SCCH on the first carrier, the second carrier, the third carrier, and the fourth carrier. A fifth combination may indicate to stop one HS-SCCH on the second carrier. A sixth combination may indicate to stop one HS-SCCH on the third carrier. A seventh combination may indicate to stop one HS-SCCH on the fourth carrier. An eighth combination may indicate to stop one HS-SCCH on the second carrier and the third carrier.

As another example, for the order type used for starting the monitoring of additional HS-SCCHs, at least 3 order bits may be available so there may be at least 8 possible combinations that may be used as follows. One combination may indicate to start one HS-SCCH on the first carrier. Another combination may indicate to start one HS-SCCH on the first carrier and one HS-SCCH on the second carrier. Another combination may indicate to start one HS-SCCH on the first carrier, the second carrier, and the third carrier. Another combination may indicate to start one HS-SCCH on the first carrier, the second carrier, the third carrier, and the fourth carrier. Another combination may indicate to start one HS-SCCH on the second carrier. Another combination may indicate to start one HS-SCCH on the third carrier. Another combination may indicate to start one HS-SCCH on the fourth carrier. Another combination may indicate to start one HS-SCCH on the second carrier and the third carrier.

A check on the UE side may be added. For example, if the number of HS-SCCHs is exceeded across active carriers, the UE may autonomously stop monitoring additional HS-SCCHs. This may be useful, for example, if the network activates a carrier with HS-SCCHs to monitor without having previously notified the UE to stop monitoring certain HS-SCCHs on the other carriers.

Although the systems, methods, and apparatus described herein may be described within the context of 3GPP UMTS wireless communications systems, they may be applied to any wireless technology using multi-carriers where control channel monitoring set is used, such as LTE, LTE-A and WiMax. For example the embodiments described herein may be extended to LTE, LTE-A, and/or WiMax. The embodiments described for HS-SCCH monitoring may be applicable for LTE, LTE-A, and/or WiMax monitoring sets. For example, HS-SCCH reception may correspond to PDCCH reception and/or HS-SCCH Channelization Code or HS-SCCH channel may correspond to the PDCCH search space. The embodiments described herein for HS-SCCH monitoring are applicable to LTE, LTE-A, and WiMax for example.

Additionally, an HS-SCCH is used as an exemplary channel for control channel monitoring in the systems, methods, and apparatus described herein. One of ordinary skill in the art will appreciate that other types of control channels may be used in the systems, methods, and apparatus described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method to control channel monitoring for multi-carrier capable operations, the method comprising:
receiving channel monitoring configurations, wherein each channel monitoring configuration identifies an active carrier configuration associated with one or more channels;
detecting a carrier change, wherein the carrier change includes at least one of a carrier activation or a carrier deactivation; and
adding a first channel for monitoring on an activated carrier when the carrier change is the carrier activation, wherein the first channel is identified by a first channel monitoring configuration corresponding to a first active carrier configuration associated with the carrier change, and wherein the first channel monitoring configuration is one of the channel monitoring configurations.

2. The method of claim 1, further comprising adding a second channel for monitoring on an existing active carrier when the carrier change is the carrier deactivation, wherein the second channel is identified by a second channel monitoring configuration corresponding to a second active carrier configuration associated with the carrier change, and wherein the second channel monitoring configuration is one of the channel monitoring configurations.

3. The method of claim 1, wherein the channel monitoring configurations are received in an RRC message.

4. The method of claim 3, wherein the adding the first channel for monitoring on the activated carrier is performed without receiving an additional RRC message.

5. The method of claim 1, further comprising deleting a third channel for monitoring on an existing active carrier when the carrier change is the carrier activation, wherein the third channel is identified by the first channel monitoring configuration corresponding to the first active carrier configuration associated with the carrier change.

6. The method of claim 5, wherein the adding and deleting maintains a maximum number of channels monitored across one or more active carriers.

7. The method of claim 1, wherein each channel monitoring configuration relates to a corresponding number of one or more active carriers.

8. The method of claim 1, wherein each channel monitoring configuration relates to a corresponding configuration of identified active carriers.

9. A device used in controlling channel monitoring for multi-carrier capable operations, the device comprising:
a transceiver in communication with a network entity, wherein the transceiver is configured to receive channel monitoring configurations from the network entity, wherein each channel monitoring configuration identifies an active carrier configuration associated with one or more channels; and
a processor configured to:
detect a carrier change, the carrier change including at least one of a carrier activation or a carrier deactivation; and
add a first channel for monitoring on an activated carrier when the carrier change is the carrier activation, the first channel being identified by a first channel monitoring configuration corresponding to a first active carrier configuration associated with the carrier change, and the first channel monitoring configuration being one of the channel monitoring configurations.

10. The device of claim 9, wherein the processor is further configured to add a second channel for monitoring on an existing active carrier when the carrier change is the carrier deactivation, wherein the second channel is identified by a second channel monitoring configuration corresponding to a second active carrier configuration associated with the carrier change, and wherein the second channel monitoring configuration is one of the channel monitoring configurations.

11. The device of claim 9, wherein the transceiver is further configured to receive the channel monitoring configurations in an RRC message.

12. The device of claim 11, wherein the processor is further configured to add the first channel for monitoring on the activated carrier without an additional RRC message being received by the transceiver.

13. The device of claim 9, wherein the processor is further configured to delete a third channel for monitoring on an existing active carrier when the carrier change is the carrier activation, wherein the third channel is identified by the first channel monitoring configuration corresponding to the first active carrier configuration associated with the carrier change.

14. The device of claim 13, wherein the processor maintains a maximum number of channels monitored across one or more active carriers.

15. The device of claim 9, wherein each channel monitoring configuration relates to a corresponding number of one or more active carriers.

16. The device of claim 9, wherein each channel monitoring configuration relates to a corresponding configuration of identified active carriers.
